(19) United States
(12) Patent Application Publication
(10) Pub. No.: US 2017/0140621 A1
(43) Pub. Date: May 18, 2017

(54) SITE PROFILING AND AUTOMATED CALIBRATION

(71) Applicant: CHECKPOINT SYSTEMS, INC., Thorofare, NJ (US)

(72) Inventors: Scott Edward Paden, Matthews, NC (US); Merril F. Bradshaw, Waxhaw, NC (US)

(21) Appl. No.: 14/938,882

(22) Filed: Nov. 12, 2015

(51) Int. Cl. G08B 13/24; G08B 29/20

(52) U.S. Cl. CPC G08B 13/2428; G08B 29/20

(57) ABSTRACT

A spectrum profiling device may be configured to generate an energy profile of a monitoring environment in which a tag adapted to be disposed on a product in the monitoring environment is detectable via a monitoring network. The device may include processing circuitry configured to receive information indicative of energy data obtained by a measurement device disposed in the monitoring environment, associate the energy data with corresponding location information describing a plurality of locations at which the energy data was obtained within the monitoring environment, and generate the energy profile providing an indication of baseline energy levels of a selected energy spectrum for the monitoring environment based on the energy data and the location information.

### TECHNICAL FIELD

Various example embodiments relate generally to retail theft deterrent and merchandise tracking equipment, and more specifically relate to providing the ability to generate profile information of a site in which retail theft deterrent and merchandise tracking equipment is to be employed so that such equipment can be selected and/or calibrated.

### BACKGROUND

Security devices have continued to evolve over time to improve the functional capabilities and reduce the cost of such devices. Some security devices are currently provided to be attached to individual products or objects in order to deter or prevent theft of such products or objects. In some cases, the security devices include tags or other such components that can be detected by gate devices at the exit of a retail establishment. When the security device passes through or proximate to the gates, an alarm locally at the product and/or at the gates may be triggered. Meanwhile, a key or deactivator may be provided at the point of sale terminal so that the security device can be removed or deactivated when the corresponding products or objects are purchased.

These security devices can also be utilized for determining location or presence of the corresponding products for product tracking and inventory purposes. The use of the security devices for these tracking and inventory purposes generally requires systems employing the security devices to be capable of longer range wireless communication with the security devices. Moreover, when conducting such wireless communication, the accuracy of the system relative to determining either location or presence may become important.

However, regardless of the purpose for which the security devices are used, many retail spaces and other spaces at which products are stored or displayed can present hostile wireless communication environments. The presence of metal shelving or equipment, the wireless communication activity of neighbors, the presence of electromagnetic interference (EMI) and other factors may all, individually or in combination, provide negative impacts on the ability of the security devices to accurately be detected or tracked.

In order to improve the ability of retailers to deter theft and track products, the security devices and systems in which they operate are continuously being improved. However, it may be difficult to determine the appropriate balance of characteristics for a given system. System tuning or calibration techniques may continue to evolve such that they can be routinely performed to deal with problems that are experienced after installation of a system, or after specific problems are experienced.

### BRIEF SUMMARY OF SOME EXAMPLES

Some example embodiments may provide an ability to identify the potential for specific problems before an installation is undertaken by allowing the space that is to be protected to have a profiling evolution completed thereon. The profiling evolution can help provide a detailed understanding of the environment and potential challenges so that intelligent decisions regarding product selection, product settings, asset placement or settings, and various other decisions related to calibration or system setup can be made.

In one example embodiment, a spectrum profiling device is provided. The device may be configured to generate an energy profile of a monitoring environment in which a tag adapted to be disposed on a product in the monitoring environment is detectable via a monitoring network. The energy profile may, for example, include an energy frequency profile indicative of energy levels measured over a range of frequencies or may include magnitude of energy measurements at one or more selected frequencies. The device may include processing circuitry configured to receive information indicative of energy data obtained by a measurement device disposed in the monitoring environment, associate the energy data with corresponding location information describing a plurality of locations at which the energy data was obtained within the monitoring environment, and generate the energy profile providing an indication of baseline energy levels of a selected energy spectrum for the monitoring environment based on the energy data and the location information.

According to another example embodiment, an environmental profiling system is provided. The system may include a measurement device to measure energy in a monitoring environment in which a tag adapted to be disposed on a product in the monitoring environment is detectable via a monitoring network, a signal generator, and a profiling manager comprising processing circuitry configured to receive information indicative of energy data obtained by the measurement device disposed in the monitoring environment, associate the energy data with corresponding location information describing a plurality of locations at which the energy data was obtained within the monitoring environment, and generate the energy profile providing an indication of baseline energy levels of a selected energy spectrum for the monitoring environment based on the energy data and the location information.

According to another example embodiment, a method of profiling a monitoring environment in which a tag adapted to be disposed on a product in the monitoring environment is detectable via a monitoring network is provided. The method may include receiving information indicative of energy data obtained by a measurement device disposed in the monitoring environment, associating the energy data with corresponding location information describing a plurality of locations at which the energy data was obtained within the monitoring environment, and generating the energy profile providing an indication of baseline energy levels of a selected energy spectrum for the monitoring environment based on the energy data and the location information.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a conceptual diagram of a commercial environment according to an example embodiment;

FIG. 2 illustrates a block diagram of an environmental profiling system that may be employed to generate a profile of a monitoring environment in which tags that may be placed on objects can be monitored in accordance with an example embodiment;

FIG. 3 illustrates a block diagram of a profiling manager in accordance with an example embodiment;

FIG. 4 illustrates a block diagram of a process flow according to an example embodiment; and

FIG. 5 illustrates a block diagram of a method of profiling a monitoring environment according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used in herein, the terms “component,” “module,” and the like are intended to include a computer-related entity, such as but not limited to hardware, firmware, or a combination of hardware, firmware and software. For example, a component or module may be, but is not limited to being, a process running on a processor, a processor, an object, an executable, a thread of execution, and/or a computer. By way of example, both an application running on a computing device and/or the computing device can be a component or module. One or more components or modules can reside within a process and/or thread of execution and a component/module may be localized on one computer and/or distributed between two or more computers. In addition, these components can execute from various computer readable media having various data structures stored thereon. The components may communicate by way of local and/or remote processes such as in accordance with a signal having one or more data packets, such as data from one component/module interacting with another component/module in a local system, distributed system, and/or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior and/or capability of the processing circuitry based on the hardware and/or software that is added to or otherwise operably coupled to the processing circuitry to configure the processing circuitry accordingly.

Indoor environments can be hostile to wireless communications for a number of different reasons. An indoor environment may have structural or design features, or may have equipment provided therein, that makes the propagation of wireless signals difficult in certain areas. Alternatively or additionally, the indoor environment may have certain areas that are exposed to interference. Moreover, some aspects of the indoor environment may have impulse response characteristics that can impact the use of radio frequency (RF) pulses in relation to various types of wireless communications.

Given that security devices (e.g., tags) that are attached to products for theft deterrent, inventory management, product tracking or locationing purposes are monitored via wireless communications, the effectiveness of these devices is correspondingly dependent upon the characteristics of the monitoring environment. Some example embodiments may therefore enable the profiling of the monitoring environment so that these characteristics can be better appreciated and accounted for when making decisions for ultimately equipment positioning, power settings, etc. In particular, where the monitoring environment is monitored using RF signaling of some type, an RF profile of the monitoring environment may be generated to identify the characteristics of the monitoring environment relative to RF signaling.

An example embodiment will be described herein in relation to a monitoring environment that employs RF signaling for a system that monitors tags on products for theft deterrent, inventory management, product tracking or locationing purposes. However, it should be appreciated that other wireless communication techniques could be employed in some cases, so the RF context described herein is merely an example of one such context in which example embodiments may be employed. If other wireless communication techniques are employed , a corresponding profile for those techniques may be generated such that, the profile can be used to provide information that can be useful in setting up, calibrating, tuning or otherwise optimizing the operation of the systems relying on the wireless communication techniques. Thus, example embodiments could also be applied to sonic spectrum, wide area networks (e.g., cellular communications), ultra wide band (UWB) applications, indoor GPS, magnetic positioning, electronic article surveillance (EAS), visible light spectrum, and/or the like. Example embodiments may also be applied to outdoor environments in some cases.

The profile generated for the monitoring environment may be an RF “heat map” of the corresponding space. The heat map may provide information indicative of the baseline characteristics of the monitoring environment. The baseline characteristics may define or include a two dimensional (2D) or three dimensional (3D) representation of the interference, impulse response and/or propagation characteristics of the monitoring environment.

By providing a profile of the monitoring environment (e.g., an RF profile), automated calibration of devices used to track and/or locate the tags can be accomplished. This automated calibration may enable retail positioning systems such as RSSI (received signal strength indication), AoA (angle of arrival), RFID systems, and/or other applications requiring indoor locationing to be optimized for the particular characteristics of the monitoring environment. The time of setup or calibration of the systems may be reduced, which may correspondingly reduce the cost of such systems by reducing installation and/or maintenance time/cost. Additionally, the accuracy of such systems may be improved by ensuring that the devices of the system are optimally configured. Thus, the ability to locate a tag on a product within an indoor monitoring environment may be improved.

Example embodiments may therefore allow specific difficult areas or situations to be identified so that system setup and device settings can be adjusted to improve performance. Example embodiments may provide an energy profile (e.g., an RF profile) that can be interpreted by a technician to perform setup and/or device setting adjustments. However, in some cases, the system may include processing circuitry configured to make recommendations regarding setup and/or settings. Thus, for example, adjustments to system parameters used in firmware to adjust the behavior of tags, FPGAs, locators, server algorithms, and/or the like, may be made in an automatic fashion in some cases.

An example embodiment will be described herein as it relates to security devices (e.g., tags) that are designed to be attached to corresponding objects (e.g., retail products) and wirelessly communicate with components of a monitoring network (e.g., an anti-theft asset monitoring network, an asset tracking network, an inventory management network, and/or the like). The network components and the tags may be configured to communicate with each other via any of a number of different communication schemes. Some of these schemes may only monitor for tags in an area proximate to an exit of the retail store being protected. Other schemes may monitor tags throughout the retail store or in various specific zones that may be defined. Furthermore, some embodiments may employ more than one communication scheme simultaneously or in a manner that allows switching between such communication schemes. Thus, communication contexts can range from relatively complex to relatively simple in various different cases.

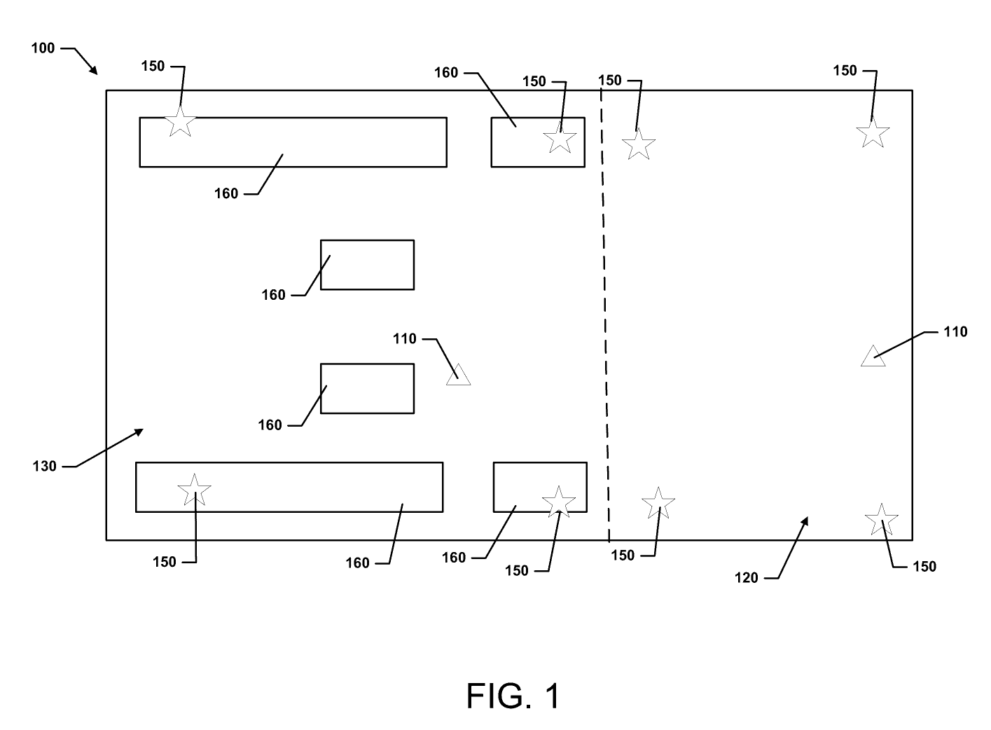

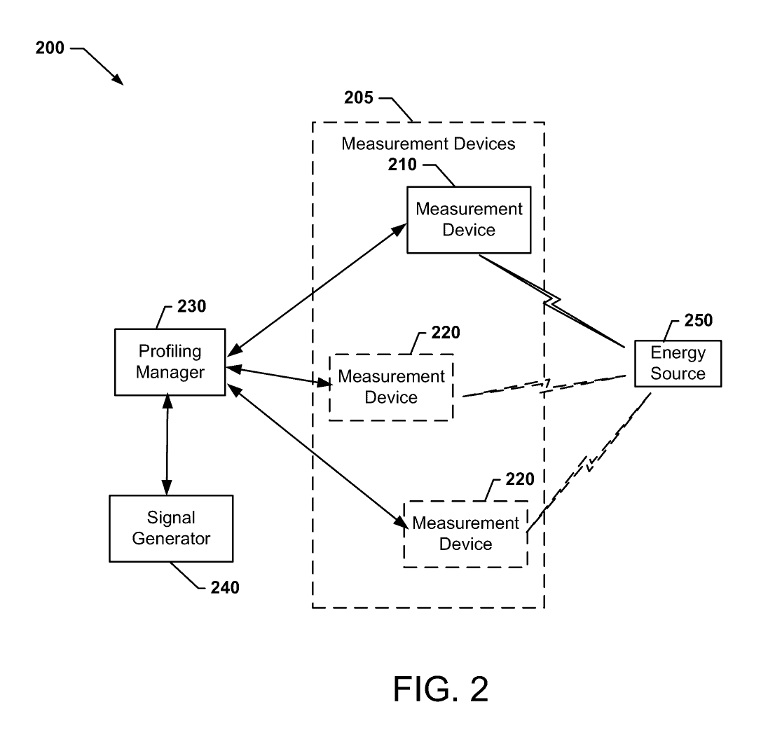

FIG. 1 illustrates a conceptual diagram of a monitoring environment within a retail store. However, it should be appreciated that other indoor (or outdoor) environments could be involved in the practice of other example embodiments. FIG. 2 illustrates a block diagram of an environmental profiling system 200 that may be employed to generate a profile of a monitoring environment 100 in which tags 110 that may be placed on objects (products) in the monitoring environment 100 can be monitored in accordance with an example embodiment. As shown in FIG. 1, the monitoring environment 100 may include a first monitoring zone 120 and a second monitoring zone 130. The first monitoring zone 120 may represent a relatively large area of the store (e.g., the sales floor). The second monitoring zone 130 may represent another area of the store. The second monitoring zone 130 could represent an area of higher sensitivity (e.g., near an exit of the store), or could simply represent another section of the store (e.g., a different department, a storage space, an area employing a different communication scheme, etc.). Thus, the first and second monitoring zones 120 and 130 could represent different physical or functional spaces, or spaces with different communication schemes or equipment. However, in some cases, the entire monitoring environment 100 could essentially employ only a single communication scheme and therefore also effectively have only one monitoring zone. Additionally, it should be appreciated that the first and second monitoring zones 120 and 130 may be exclusively defined or, in some embodiments, the second monitoring zone 130 may exist within and/or overlap with the first monitoring zone 120.

As shown in FIG. 1, the tag 110 may be capable of wireless communication with one or more wireless communication points (CPs) 150 that may be positioned in or proximate to the commercial environment 100. The CPs 150 may be capable of employment within a tag detection or location system or in connection with determining tag 110 presence and/or identity. The CPs 150 may be access points, transmitters, receivers or transceivers associated with a local or wide area communication network, or may be any other wireless communication devices that are capable of detecting the presence (and in some cases also identity) of the tag 110. Thus, for example, the CPs 150 may be wireless transmitters, receivers or transceivers associated with or embodied as, for example, WiFi presence detection systems, real-time locating system (RTLS) locating techniques via WiFi or Bluetooth (e.g., angle of arrival (AOA), time difference of arrival (TDOA), etc.), global positioning system (GPS) locationing systems, AoA systems, RSSI systems, EAS systems, near field communication (NFC) (e.g., RFID), magnetic sampling or sensing, and/or the like.

In some cases, the CPs 150 may be at fixed locations within the first and/or second monitoring zones 120 and 130, and one or more instances of the CPs 150 may be located in each of the first and second monitoring zones 120 and 130. However, in some examples, the CPs 150 may be mobile, such as when the CPs 150 represent handheld reading devices (e.g., a handheld RFID reader), or robotic communication devices. Each of the CPs 150 may cover a predefined area, or the CPs 150 may interact with each other to determine the location of the tag 110 within the monitoring environment 100. In an example embodiment, the CPs 150 may be operably coupled to each other or to a system controller via a wired or wireless network to form the monitoring network that is used to monitor the tags 110 within the monitoring environment 100.

As shown in FIG. 1, either or both of the first and second monitoring zones 120 and 130 may include structures 160 on which products may be displayed or stored. However, in some cases, the structures 160 may represent counters, desks or other structures at which other retail store functions may be performed (e.g., customer service, point of sale operations, etc.). Walls, racks, equipment and any other physical things that can block wireless signaling may also be represented by the structures 160. As may be appreciated from FIG. 1, dependent upon the thickness, height, location and material of the structures 160, the ability of the CPs 150 to cover certain areas may be inhibited to at least some degree by the structures 160. Thus, the structures 160 may play a role in defining the impulse response and the RF profile of the monitoring environment based on the positioning of the CPs 150 and/or the tags 110 relative to the structures 160. In some cases, some of the structures 160 (or other parts of the monitoring environment 100) may have electrical equipment operating therein or nearby, which may generate EMI in the vicinity or otherwise further impact signal propagation. Other communications equipment operating nearby the monitoring environment 100 or in association with the structures 160 may also generate interference that could be measured and characterized.

Accordingly, the environmental profiling system 200 of FIG. 2 can be configured to enable measurement of baseline information using receiving equipment configured to detect energy in a corresponding desired spectrum of interest within the monitoring environment 100. The baseline information, which may represent energy measurements in the spectrum of interest at known locations, may then be used by equipment in communication with the environmental profiling system 200 to generate an energy profile of the monitoring environment 100. The energy profile may be, for example, an impulse response profile, a RF propagation profile, or an RF interference profile. However, similar profiles could be produced for other spectra as well.

As shown in FIG. 2, the environmental profiling system 200 may include one or more measurement devices 205. One of the measurement devices 205 of FIG. 2 is a mobile measurement device 210, and is shown in solid lines to illustrate that some embodiments can have as little as a single (mobile) measurement device. However, remaining ones of the measurement devices 205 are shown in dashed lines to illustrate fixed measurement devices 220. Although FIG. 2 shows one mobile asset and two fixed assets, it should be appreciated that as little as one asset of either type (mobile or fixed) could be used in some embodiments, and many assets (again of either type) could be employed in other embodiments. Thus, some embodiments may employ all fixed, all mobile, or combinations of fixed and mobile assets as the measurement devices, while other embodiments may employ only a single asset.

The measurement devices 205 (e.g., the mobile measurement device 210 and the fixed measurement devices 220) may be capable of wired or wireless communication with a profiling manager 230 of an example embodiment. The profiling manager 230 may be configured to interface with the measurement devices 205 to measure energy levels detected at each of the measurement devices 205 and associate the measured energy levels with the known locations of the measurement devices 205 when the corresponding energy levels were measured. In some embodiments, the profiling manager 230 may be configured to communicate with a signal generator 240 so that the signal generator 240 can transmit pulsed RF or other RF signals at any desirable frequency, or over a range of frequencies, so that returns from the monitoring environment 100 after generation of the pulsed RF or other RF signals can be measured by the measurement devices 210 and 220.

In an example embodiment, the measurement devices 205 may measure energy from an energy source 250 that may be detectable in the monitoring environment 100. In some cases, the energy source 250 may be a known source of energy that is generated under the control of or with the knowledge of the profiling manager 230. For example, when the signal generator 240 is employed to transmit pulsed RF, the energy source 250 could be considered to be the signal generator 240 or reflected impulse response energy detected by the measurement devices 210 and 220. In other cases, where the signal generator 240 is used to transmit RF of any desirable frequency or range of frequencies, the signal generator 240 and/or the propagated and/or reflected signals that pass through the monitoring environment 100 to the measurement devices 205 may be considered to be the energy source 250. However, in other embodiments, the measurement devices 205 may simply measure energy levels detected in the environment in a passive way to detect EMI sources or other interfering signals in the monitoring environment 100. Thus, the energy source 250 may actually be signal energy generated external to the monitoring environment 100, or may be generated by unknown sources.

In some cases, the entire environmental profiling system 200 may be a movable system that can be moved to and set up in the monitoring environment 100, and then moved to another monitoring environment to be set up for profiling there. Thus, for example, the profiling manager 230, the signal generator 240 (if employed), and the measurement devices 205 may be a kit that is used independent of the CPs 150 of the monitoring environment 100. The measurement devices 205 can be set up or moved throughout the monitoring environment 100 to measure energy levels generated within the monitoring environment 100 (e.g., by passive measurement of the energy source 250, or by measurement of energy actively produced by the signal generator 240). In any case, the locations of the measurement devices 205 for each instance in which energy data is gathered may also be recorded in association with the corresponding energy data. The profiling manager 230 may then generate an energy profile as described in greater detail below based on the energy data.

In other examples, the measurement devices 205 may actually be the CPs 150 themselves, and the profiling manager 230 (and perhaps also the signal generator 240) may be integrated with an existing monitoring network to receive energy data gathered by the CPs 150 (passively or based on active transmissions as described above). In such an example, the locations of the CPs 150 may be the locations of the respective measurement devices 205 in relation to gathering the energy data for analysis by the profiling manager 230. Thus, in this example, the profiling manager 230 and the signal generator 240 (if employed) may form the kit, and the kit can be plugged in or otherwise operably coupled with existing CPs 150.

In still other examples, the profiling manager 230 may be an entity or module that is embodied at a system controller of an existing monitoring network installed in the monitoring environment 100. Thus, for example, none of the components of the environmental profiling system 200 may necessarily be mobile or form a portion of a kit. Instead, the profiling manager 230 may be permanently embedded into the monitoring network of the monitoring environment 100 and permanently operably coupled to the CPs 150 or to dedicated measurement devices that are distinct from the CPs 150. In such an example, the monitoring network may have a calibration or setup guidance mode in which the profiling manager 230 (and perhaps also the signal generator 240) becomes operable to interface with the measurement devices 205 to perform energy profiling as described herein.

In embodiments where the mobile measurement device 210 is employed, the mobile measurement device 210 may be embodied as a robot, a drone, a handheld reader and/or the like. Regardless of how the mobile measurement device 210 is implemented, the mobile measurement device 210 may employ an accurate positioning system, so that the position of the mobile measurement device 210 can be known at each instance in which energy data is recorded.

In some cases, the mobile measurement device 210 may utilize an accelerometer or other inertial navigation mechanisms to determine position relative to one or more known reference points (e.g., a charging station) within the monitoring environment 100. However, in other examples, the mobile measurement device 210 may itself employ wireless signaling to accurately determine its location in the monitoring environment 100. The location information that is determined for the mobile measurement device 210 may be determined in 2D (e.g., on an x, y coordinate grid) or 3D (e.g., on an x, y, z coordinate grid). If 3D location is employed, the mobile measurement device 210 may be a drone or a robot with the capability of extending a receiver up and down to known heights to take measurements along the z axis when moving to known locations on the x, y coordinate grid. Energy data measured by the mobile measurement device 210 may be transmitted in real-time to the profiling manager 230, or may be stored locally for burst transmission at a later time, or for transfer when a physical connection can be made with the profiling manager 230.

In instances in which the fixed measurement devices 220 are employed, the location of the fixed measurement devices 220 may be known or determined and then recorded so that energy data recorded (at any desired interval) can be recorded in association with the corresponding known locations of the fixed measurement devices 220. Combinations of fixed and mobile measuring devices can also be employed.

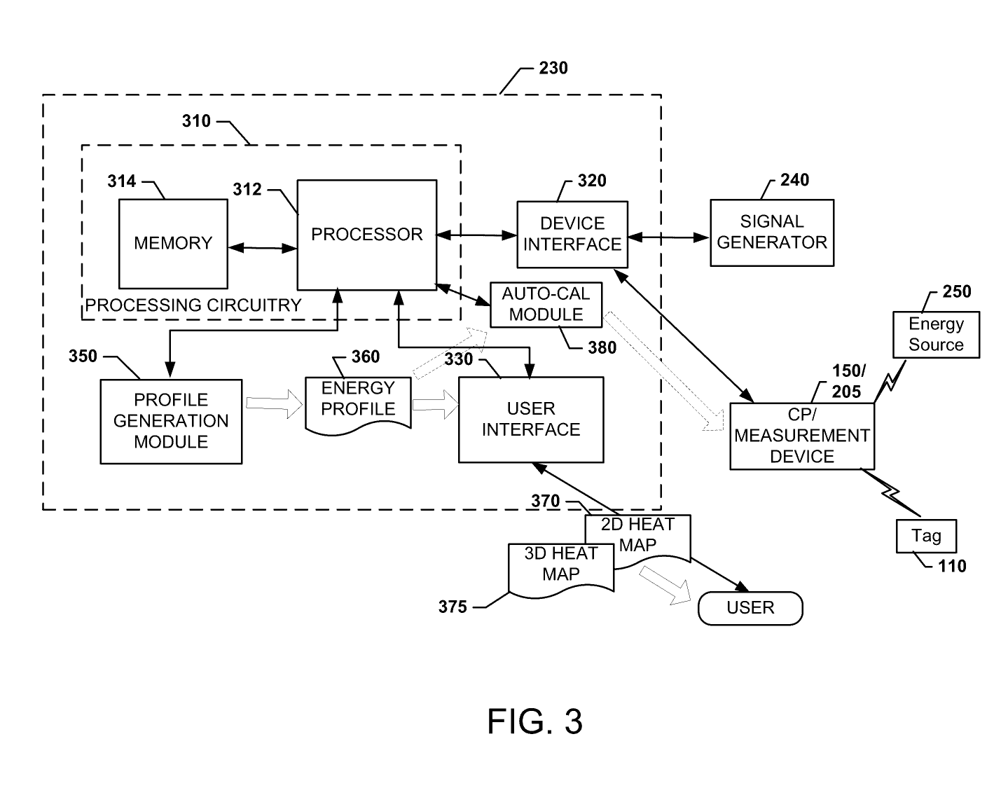

As discussed above, the profiling manager 230 may be employed to determine an energy profile based on the energy data (e.g., location information associated with the physical position of the measurement devices 205 and the energy levels measured thereat). One example structure of the profiling manager 230 is shown in FIG. 3. In this regard, the profiling manager 230 may include processing circuitry 310 that may be configured to interface with, control or otherwise coordinate the operations of various components or modules described herein in connection with generating (and perhaps also using) energy profiles as described herein. The profiling manager 230 may utilize the processing circuitry 310 to provide electronic control inputs to one or more functional units of the profiling manager 230 to receive, transmit and/or process data associated with the one or more functional units and perform communications necessary to enable the ability to utilize energy data to generate an energy profile as described herein.

In some embodiments, the processing circuitry 310 may be embodied as a chip, chip set, or module. In other words, the processing circuitry 310 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry 310 may therefore, in some cases, be configured to implement an example embodiment on a single chip or as a single “system on a chip” or “system on a module.” As such, in some cases, a chip or chipset may constitute means for performing one or more operations for providing the functionalities described herein.

In an example embodiment, the processing circuitry 310 may include one or more instances of a processor 312 and memory 314 that may be in communication with or otherwise control a device interface 320, and in some cases also a user interface 330. As such, the processing circuitry 310 may be embodied as a circuit chip (e.g., an integrated circuit chip) configured (e.g., with hardware, software or a combination of hardware and software) to perform operations described herein.

The user interface 330 may be in communication with the processing circuitry 310 to receive an indication of a user input at the user interface 330 and/or to provide an audible, visual, tactile or other output to the user. As such, the user interface 330 may include, for example, a touch screen, one or more switches, buttons or keys (e.g., function buttons), mouse, joystick, keyboard, and/or other input mechanisms. In an example embodiment, the user interface 330 may include one or a plurality of lights, a display, a speaker, a tone generator, a vibration unit and/or the like as potential output mechanisms.

The device interface 320 may include one or more interface mechanisms for enabling communication with other devices (e.g., CPs 150, measurement devices 205, the signal generator 240 (if employed), and/or other devices). In some cases, the device interface 320 may be any means such as a device or circuitry embodied in either hardware, or a combination of hardware and software that is configured to receive and/or transmit data from/to devices or components in communication with the processing circuitry 310 via internal and/or external communication mechanisms. Accordingly, for example, the device interface 320 may further include wired and/or wireless communication equipment (e.g., one or more antennas) for at least communicating with CPs 150, measurement devices 205, the signal generator 240 (if employed), and/or the modules described herein. In some cases, the device interface 320 may therefore include one or more antenna arrays that may be configured or configurable to receive and/or transmit properly formatted signals associated with CPs 150, measurement devices 205, or the signal generator 240 (if employed). The device interface 320 may further include radio circuitry configured to encode and/or decode, modulate and/or demodulate, or otherwise process wireless signals received by or to be transmitted by the antenna array(s). In examples in which magnetic sensors are employed, the device interface 320 may further include circuitry for enabling data from such sensors to be provided to the processing circuitry 310 and/or profile generation module 350 for processing and/or analysis. In embodiments in which sound or light are detected, microphones, speakers, light sensors and/or light emitters may be employed.

The processor 312 may be embodied in a number of different ways. For example, the processor 312 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor 312 may be configured to execute instructions stored in the memory 314 or otherwise accessible to the processor 312. As such, whether configured by hardware or by a combination of hardware and software, the processor 312 may represent an entity (e.g., physically embodied in circuitry—in the form of processing circuitry 310) capable of performing operations according to some example embodiments while configured accordingly. Thus, for example, when the processor 312 is embodied as an ASIC, FPGA or the like, the processor 312 may be specifically configured hardware for conducting the operations described herein. Alternatively, as another example, when the processor 312 is embodied as an executor of software instructions, the instructions may specifically configure the processor 312 to perform the operations described herein in reference to execution of an example embodiment.

In an exemplary embodiment, the memory 314 may include one or more non-transitory memory devices such as, for example, volatile and/or non-volatile memory that may be either fixed or removable. The memory 314 may be configured to store information, data, applications, instructions or the like for enabling the processing circuitry 310 to carry out various functions in accordance with exemplary embodiments. For example, the memory 314 may be configured to buffer input data for processing by the processor 312. Additionally or alternatively, the memory 314 may be configured to store instructions for execution by the processor 312. As yet another alternative or additional capability, the memory 314 may include one or more databases that may store a variety of data sets or tables useful for operation of the modules described below and/or the processing circuitry 310. Among the contents of the memory 314, applications or instruction sets may be stored for execution by the processor 312 in order to carry out the functionality associated with each respective application or instruction set. In some cases, the applications/instruction sets may include instructions for carrying out some or all of the operations described in reference to the algorithms or flow charts described herein. In particular, the memory 314 may store executable instructions that enable the computational power of the processing circuitry 310 to be employed to control operation of the signal generator 240, and/or to interface with the measurement devices 205 to receive energy data. Instructions may then also be executed to implement functionality attributed to a profile generation module 350 and/or an automatic calibration module 380, as described herein.

As shown in FIG. 3, the profiling manager 230 may further include (or otherwise be operably coupled to) the profile generation module 350 and/or the automatic calibration module 380. In some examples, the processor 312 (or the processing circuitry 310) may be embodied as, include, or otherwise control various modules (e.g., the profile generation module 350 and the automatic calibration module 380) that are configured to perform respective different tasks associated with the profiling manager 230. As such, in some embodiments, the processor 312 (or the processing circuitry 310) may be said to cause each of the operations described in connection with the various modules described herein. However, it should be appreciated that the modules could be remotely located from the processing circuitry 310 in some cases and may therefore employ their own processing circuitry in such cases.

The profile generation module 350 may be any means such as a device or circuitry embodied in either hardware, or a combination of hardware and software that is configured to receive energy data including energy measurements and corresponding (2D or 3D) location information indicative of the location at which the energy measurements were made, and transform the energy data into an energy profile 360. The energy profile 360 correlates the energy measurements to the location information for provision to the user (e.g., via the user interface 330) in a graphical representation that may, for example, be overlaid on a map of the monitoring environment 100. Thus, in some cases, the energy profile 360 may be provided to the user in the form of a 2D heat map 370 or a 3D heat map 375.

In some cases, the discrete measurements associated with each location at which the energy measurements were made could be displayed. However, in other examples, the discrete values may be employed to generate a graphical representation that provides estimates of values between the locations where the discrete measurements were made. Thus, although discrete measurements are made at various locations, a continuous estimate and corresponding display of energy levels at all locations of the monitoring environment 100 may be provided. The discrete measurements may be indicative of a power level for a particular frequency measured. Each point may indicate a Fast Fourier Transform (FFT) over time (perhaps 1 or multiple FFTs in the order of milliseconds, second or minutes). Each point may have a plot of a long period of time to cover multiple iterations of measurements over the period of time covered.

Colors or other distinguishing visual representation features may be provided to indicate the energy levels at each location where different colors indicate corresponding different levels of energy intensity estimated at each respective location. In the 2D heat map 370, energy levels measured (and estimated between such measurements) may simply be displayed on a 2D grid (e.g., an x,y coordinate grid that corresponds to the monitoring environment 100). However, for the 3D heat map 375, energy levels measured (and estimated between such measurements) may be displayed on a 3D grid (e.g., an x,y, z coordinate grid that corresponds to the monitoring environment 100). In some cases, the 3D heat map 375 may include a plurality of 2D heat maps that can be parsed or reviewed based on a selected elevation. Thus, the 3D heat map 375 could be modeled as a plurality of 2D heat maps overlaid over each other based on elevation. However, more complex modeling and display techniques of the 3D data may be presented in some cases.

As can be appreciated from the description above, the profile generation module 350 may be configured to transform energy measurements from a particular physical space (e.g., the monitoring environment 100) into a graphical representation of the physical space and the estimated energy levels (of a selected energy spectra) at all points within such physical space. The profile generation module 350 may be utilized to generate the energy profile 360 for display to the user. The user may then review the energy profile 360 to appreciate baseline conditions for various characteristics of the monitoring environment 100 that will impact the performance of wireless communication equipment (e.g., of the monitoring network) when such equipment is operated in the monitoring environment 100. The user may therefore make decisions about areas where additional equipment or specific equipment settings may be desirable (e.g., to enhance coverage or accuracy).

Although the graphical representation of the energy profile 360 may be the final resultant output in some cases, the energy profile 360 may be used to drive further capabilities of the profiling manager 230 in some cases. In this regard, for example, the profiling manager 230 may further include the automatic calibration module 380. The automatic calibration module 380 may be any means such as a device or circuitry embodied in either hardware, or a combination of hardware and software that is configured to receive the energy profile 360 and receive system configuration information to enable the automatic calibration module 380 to suggest or make adjustments to the system configuration information. The system configuration information may be indicative of the CPs 150 and/or other equipment of the monitoring network, and may further indicate current settings (e.g., power levels, operating channels, frequency settings, and/or the like) of the monitoring network. The automatic calibration module 380 may be configured to determine, based on the energy profile 360, whether additional CPs could be added to the system or whether current settings or configuration of the CPs 150 and any system controller to which the CPs 150 communicate data for monitoring the tags 110 could be adjusted to improve performance. The automatic calibration module 380 may be configured to make such adjustments automatically in some cases, or may automatically generate a report recommending such adjustments for the user. In an example embodiment, the automatic calibration module 380 may be configured to make adjustments and then receive an updated energy profile that may be generated after such adjustments have been made. In this way, the automatic calibration module 380 and the profile generation module 350 may interact in real time or in an iterative fashion to progressively tune or calibrate system components by making adjustments and then creating a new energy profile to determine whether the adjustments made have had the desired effects.

As stated above, the energy profile 360 may include any or a selected one of an interference profile, a propagation profile, or an impulse response profile. The interference profile may be a passive snapshot of existing or ambient RF (or other spectrum) energy levels at various locations in the monitoring environment 100. Thus, for generation of the energy profile 360 as providing interference characteristics, the measurement devices 205 may be configured as passive listeners within the monitoring environment 100. In an example embodiment, the measurement devices 205 may be configured to receive frequency data over a wide band of frequencies, or over the specific bands that may be employed by the monitoring network that is or may operate within the monitoring environment. An RF interference profile may therefore be generated that may include EMI generated by power transformers, electrical wiring and other EMI sources. The RF interference profile may also or alternatively identify specific frequencies present at given locations (perhaps also at different times) within the monitoring environment 100. The RF interference profile can therefore become part of a calibration profile used to determine the setup and steady state use parameters of the monitoring network installed in the monitoring environment 100. As such, although the RF interference profile could be used to provide a baseline profile before the monitoring network is installed, the RF interference profile could also be used at predefined intervals or in response to triggering events in order to generate updates to the baseline profile over time. In such examples, the monitoring network may be shutdown while the RF interference profile is determined.

The propagation profile could be generated based on the use of calibrated or specialized tags and locators. Thus, for example, the measurement devices 205 and the signal generator 240 (or other energy sources 250 such as calibrated “test” tags) may be calibrated devices with known parameters placed in such a manner as to allow the monitoring environment 100 to be fully covered and characterized by, for example, an RF propagation profile. The measurement devices 205 may therefore gather data that the profiling manager 230 is configured to interpret to define reflection points in the monitoring environment and an illustration of the impacts that such reflection points have on blocking coverage in some areas or creating interference in others. Areas of constructive and destructive interference may therefore be identified so that, where possible, the monitoring network can be manipulated (physically or based on configuration settings) to improve monitoring network performance. Performance may be improved by adding locators or beacons, choosing strategic locations for locators or beacons, adding materials (e.g., RF foil, Faraday materials, screens, etc.) or adjusting setup parameters used during initial installation or for calibration while the monitoring network is otherwise in use.

The impulse response profile may be generated in connection with calibrated or specialized tags or impulse beacons that are placed in the monitoring environment 100. Thus, for example, the measurement devices 205 and the signal generator 240 may be calibrated devices with known parameters placed in such a manner as to allow the monitoring environment 100 to be flooded with RF pulses so the returns can be measured and characterized by, for example, an RF impulse response profile. Thus, the signal generator 240 may send an RF pulse to create a wide band impulse response that can be recorded by the measurement devices 205 to generate the RF impulse response profile.

The RF impulse response profile can be generated before the monitoring network is installed, or periodically after installation in order to be used for calibration or repositioning of monitoring network components (e.g., the CPs 150, system controller, and/or the like). Thus, for example, profiling could be accomplished nightly, or on a periodic or aperiodic cycle during the day. In some cases, other RF signals can also be sent in addition to RF pulses. Various test signals could be used including randomized RF white noise, RF sweep signals, and other types of signals. As discussed above, performance may be improved by adding locators or beacons, choosing strategic locations for locators or beacons, adding materials (e.g., RF foil, Faraday materials, screens, etc.) or adjusting setup parameters used during initial installation or for calibration while the monitoring network is otherwise in use to improve impulse response.

Accordingly, the profiling manager 230 may be configured (e.g., via the profile generation module 350 and the automatic calibration module 380) to measure current energy levels (passively or actively) to generate an energy profile (e.g., energy profile 360). In some cases, the energy profile 360 may be the output, but in other cases, further automated activity may occur. For example, after receipt of the energy profile 360, the profiling manager 230 may be configured to then make adjustments (or provide an output listing suggested adjustments) to the configuration of system components in real time or in an iterative fashion to improve system performance. The profiling manager 230 may therefore transform energy measurements into a graphical representation that provides a profile of the monitoring environment 100 relative to propagation characteristics, interference characteristics, impulse response characteristics, and/or the like. The profiling manager 230 could even generate combinations of profiles on any desirable schedule. The profiles may then be used for automatic adjustment of the devices of the monitoring network.

By employing the profiling manager 230, hours of setup time may be reduced since a coherent plan regarding which type of system to employ as the monitoring network based on the energy profile, and/or recommendations for locating CPs 150 of the monitoring network. Channel selection, frequency and/or gain settings, transmit and/or receive power levels, and other settings may be intelligently selected and routinely updated based on operation of the profiling manager 230. Thus, a targeted setup and intelligent maintenance may be performed relative to the assets of the monitoring network. Accuracy of the monitoring network may also be increased so that theft prevention is improved. The occurrence of loss, organized retail crime or missing inventory may also be improved by improving the accuracy of locationing of the tags 110.

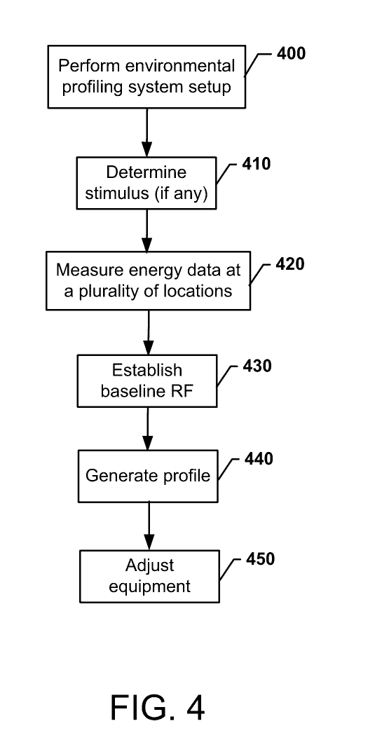

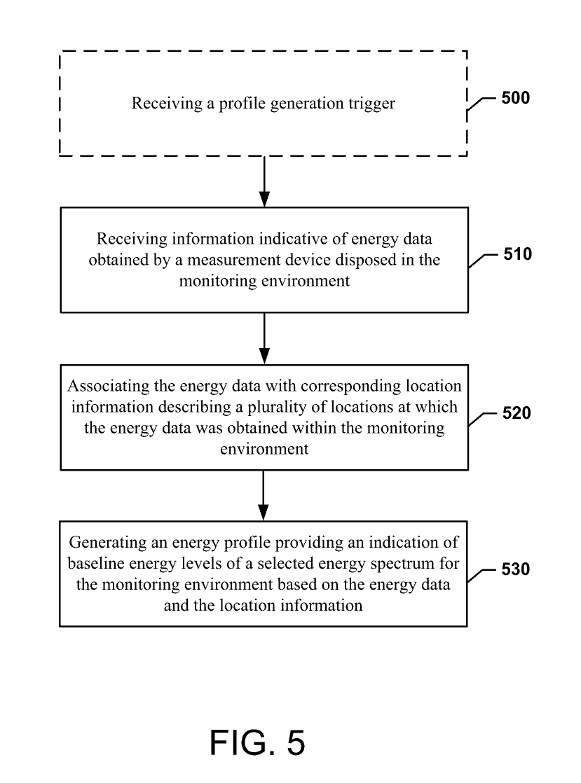

From a technical perspective, the profiling manager 230 described above may be used to support some or all of the operations described above. As such, the platforms described in FIGS. 1-3 may be used to facilitate the implementation of one or more computer program and/or network communication based interactions. As an example, FIGS. 4-5 are flowcharts of example methods and program products according to respective example embodiments. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 4 illustrates a block diagram showing a control flow representative of an algorithm executable in connection with a system employing the profiling manager 230 in accordance with an example embodiment. As shown in FIG. 4, environmental profiling system setup may initially be performed at operation 400. The environmental profiling system setup may include placement and coupling of equipment. In this regard, for example, if the environmental profiling system is a kit including its own measurement devices (whether fixed or mobile), the measurement devices may be placed in the monitoring environment in desired locations, or a routing plan may be determined. At operation 400, details regarding movement of the measurement devices, energy sources and/or the like (e.g., beacons, locators, transmitters and/or receivers) may be determined or otherwise considered to ensure that the monitoring environment is covered sufficiently to generate useful profile information.

Thereafter, at operation 410, a determination may be made as to what stimulus (if any) is desired for the selected energy profile that is to be generated. Thus, for example, if an RF impulse response profile or propagation profile is to be generated, the bandwidth, time domain characteristics, power level, and frequency to be generated should be determined. In some cases, FCC or other government requirements should be consulted to ensure that power levels are attenuated or shielded appropriately to avoid violation of any applicable regulations. However, power levels, or the number and placement of equipment, should be determined to adequately cover the monitoring environment. In examples where no stimulus is desired, the monitoring network should be verified in a shutdown or off state, so that the energy levels measured are clearly environmental levels that are not generated by the monitoring network itself The measurement devices may therefore “sniff” the environment for WiFi, EMI or other potential interferers such as light, sonic, or magnetic interference in contexts other than an RF context.

At operation 420, energy data may be measured at a plurality of locations. The measured energy data may be a snapshot or series of snapshots taken over time. In some cases, the measured energy data may be used to generate a histogram or waterfall display of frequency and power over time (e.g., an FFT over time). As discussed above, the measurement may be accomplished at fixed locations (which may be known), or by accurately monitoring movement of a mobile measurement device and recording the corresponding energy levels detected at the locations the mobile measurement device transits on a route through the monitoring environment. In either case, the energy levels are recorded as energy data along with associated location information.

At operation 430, baseline RF (or other spectrum) may be established for the monitoring environment. In this regard, the energy data may represent a baseline spectrum measurement (i.e., with transmitters of the monitoring network powered off or otherwise not operational) to identify the spectral content or activity of interest for the monitoring environment so that impacts on operation of the monitoring network can be better anticipated and, where appropriate, accounted for. One goal that may be achieved by some embodiments is to minimize interference to prevent collisions and re-transmits in order to decrease latency and improve throughput timeliness and system response. The output of this stage, in some cases, may be a set of frequencies or channels that should be used (or not used) by the system to avoid collisions and interference.

At operation 440, a profile may be generated for the selected spectrum and/or of the selected type (e.g., RF propagation profile, RF interference profile, RF impulse response profile, etc.). The profile may map the stimulus response, or passively gathered energy data in the frequency domain and/or the time domain for given locations at which the energy data is gathered. Phase data and propagation effects over time may also be mapped. The profile may enable an identification of constructive and/or destructive interference based on the inherently present sources of energy, and the way energy interacts with the structures that define the monitoring environment.

Thereafter, at operation 450, specific adjustments to equipment may be automatically performed (or suggested). The adjustments may include changing equipment locations, adding additional equipment, altering channels used, changing power levels, or other modifications to the monitoring environment or the monitoring network.

FIG. 5 illustrates a block diagram of a method of profiling a monitoring environment in accordance with an example embodiment. In this regard, for example, the method may include an optional operation of receiving a profile generation trigger at operation 500. The profile generation trigger may be automatically or manually generated. Manual generation of the trigger may be initiated by an operator after setup of the environmental profiling system 200 prior to monitoring network deployment or activation (e.g., during the setup phase). Automatic generation of the profile generation trigger may be implemented when the profiling manager 230 is embodied as a part of the monitoring network, and is configured to operate based on predefined temporal triggers (e.g., according to a time schedule), or based on event triggers. The method may further include receiving information indicative of energy data obtained by a measurement device (i.e., one or more mobile or fixed measurement devices) disposed in the monitoring environment at operation 510. At operation 520, the energy data may be associated with corresponding location information describing a plurality of locations at which the energy data was obtained within the monitoring environment. Of note, operations 510 and 520 could be combined into a single operation in some cases. Thereafter, at operation 530, the method may include generating an energy profile providing an indication of baseline energy levels of a selected energy spectrum for the monitoring environment based on the energy data and the location information.

The profiling manager 230 may be a device that is configured (via processing circuitry) to perform the operations described in association with FIGS. 4 and 5. In some embodiments, the features described above may be augmented or modified, or additional features may be added. These augmentations, modifications and additions may be optional and may be provided in any combination. Thus, although some example modifications, augmentations and additions are listed below, it should be appreciated that any of the modifications, augmentations and additions could be implemented individually or in combination with one or more, or even all of the other modifications, augmentations and additions that are listed. As such, for example, the energy profile may be generated responsive to a profile generation trigger. In some cases, the processing circuitry may be further configured to adjust settings of equipment used to detect the tag based on the energy profile. In some cases, the processing circuitry may be further configured to output a suggested location adjustment to a location of equipment used to detect the tag based on the energy profile. In some cases, the energy profile includes a 2D or 3D energy profile. In some cases, the selected energy spectrum is the RF spectrum, and the energy profile includes a selected one of an RF impulse response profile, an RF interference profile, and an RF propagation profile. In some cases, the device may be a component of a kit including fixed measurement devices disposed at known locations of the monitoring environment, or a component of a kit including a mobile measurement device that records the energy data while transiting through the monitoring environment. In some cases, the mobile measurement device is a robot, a handheld reader, or a drone. In some cases, the baseline energy levels are determined without operation of the monitoring network. In some cases, the measurement device may include a communication point of the monitoring network. Other modifications are also possible.

Example embodiments may provide a robust capability for profiling monitoring environments prior to and after deployment of a monitoring network. The configuration of the monitoring network may therefore be more quickly established initially, and may be tuned or calibrated both initially and during operation with periodically generated profiles of any desired type.

Many modifications and other embodiments of the examples set forth herein will come to mind to one skilled in the art to which these examples pertain having the benefit of the teachings presented in the foregoing descriptions and the associated drawings. Therefore, it is to be understood that the examples are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A device configured to generate an energy profile of a monitoring environment in which a tag adapted to be disposed on a product in the monitoring environment is detectable via a monitoring network, the device comprising processing circuitry configured to:
receive information indicative of energy data obtained by a measurement device disposed in the monitoring environment;
associate the energy data with corresponding location information describing a plurality of locations at which the energy data was obtained within the monitoring environment; and
generate the energy profile providing an indication of baseline energy levels of a selected energy spectrum for the monitoring environment based on the energy data and the location information.

2. The device of claim 1, wherein the energy profile is generated responsive to a profile generation trigger.

3. The device of claim 1, wherein the processing circuitry is further configured to adjust settings of equipment used to detect the tag based on the energy profile.

4. The device of claim 1, wherein the processing circuitry is further configured to output a suggested location adjustment to a location of equipment used to detect the tag based on the energy profile.

5. The device of claim 1, wherein the energy profile comprises a two dimensional energy profile.

6. The device of claim 1, wherein the energy profile comprises a three dimensional energy profile.

7. The device of claim 1, wherein the selected energy spectrum is a radio frequency (RF) spectrum, and wherein the energy profile comprises a selected one of an RF impulse response profile, an RF interference profile, and an RF propagation profile.

8. The device of claim 1, wherein the device is a component of a kit including fixed measurement devices disposed at known locations of the monitoring environment.

9. The device of claim 1, wherein the device is a component of a kit including a mobile measurement device that records the energy data while transiting through the monitoring environment.

10. The device of claim 9, wherein the mobile measurement device is a robot, a handheld reader, or a drone.

11. The device of claim 1, wherein the baseline energy levels are determined without operation of the monitoring network.

12. The device of claim 1, wherein the measurement device comprises a communication point of the monitoring network.

13. An environmental profiling system comprising:
a measurement device to measure energy in a monitoring environment in which a tag adapted to be disposed on a product in the monitoring environment is detectable via a monitoring network;
a signal generator; and
a profiling manager comprising processing circuitry configured to:
receive information indicative of energy data obtained by the measurement device disposed in the monitoring environment;
associate the energy data with corresponding location information describing a plurality of locations at which the energy data was obtained within the monitoring environment; and
generate the energy profile providing an indication of baseline energy levels of a selected energy spectrum for the monitoring environment based on the energy data and the location information.

14. The system of claim 13, wherein the processing circuitry is further configured to adjust settings of equipment of the monitoring network used to detect the tag based on the energy profile.

15. The system of claim 13, wherein the processing circuitry is further configured to output a suggested location adjustment to a location of equipment of the monitoring network used to detect the tag based on the energy profile.

16. The system of claim 13, wherein the energy profile comprises a two dimensional energy profile or a three dimensional energy profile.

17. The system of claim 13, wherein the selected energy spectrum is a radio frequency (RF) spectrum, and wherein the energy profile comprises a selected one of an RF impulse response profile, an RF interference profile, and an RF propagation profile.

18. The system of claim 1, wherein the measurement device comprises a communication point of the monitoring network.

19. A method of profiling a monitoring environment in which a tag adapted to be disposed on a product in the monitoring environment is detectable via a monitoring network, the method comprising:
receiving information indicative of energy data obtained by a measurement device disposed in the monitoring environment;
associating the energy data with corresponding location information describing a plurality of locations at which the energy data was obtained within the monitoring environment; and
generating the energy profile providing an indication of baseline energy levels of a selected energy spectrum for the monitoring environment based on the energy data and the location information.

20. The method of claim 19, further comprising adjusting settings of equipment used to detect the tag based on the energy profile.
